(19) United States
(12) Patent Application Publication
(10) Pub. No.: US 2013/0300200 A1
(43) Pub. Date: Nov. 14, 2013

(54) Auxiliary Battery

(71) Applicant: MAGNADYNE CORPORATION, Compton, CA (US)

(72) Inventor: CM Wong, Scarborough (CA)

(73) Assignee: Magnadyne Corporation, Compton, CA (US)

(21) Appl. No.: 13/622,863

(22) Filed: Sep. 19, 2012

Related U.S. Application Data
(60) Provisional application No. 61/646,038, filed on May 11, 2012.

(51) Int. Cl. H02J 7/00

(52) U.S. Cl. CPC H02J 7/0063
USPC 307/48

(57) ABSTRACT

Disclosed is an adapter configured to couple an auxiliary battery for use with a portable device. The adapter is configured to house the OEM battery and the auxiliary battery. The power of the auxiliary battery is coupled in parallel to the OEM battery to extend the power capacity of the portable device. The adapter is further configured to isolate non-power contacts of the auxiliary battery from the portable device and from an OEM battery so as to avoid interference with any authentication circuits of the portable device or OEM battery.

### CROSS REFERENCE TO RELATED APPLICATIONS

The present application claims the benefit of provisional patent application No. 61/646,038 (Ser. No. 12/761,055) in the names of C M Wong, filed May 11, 2012.

### FIELD OF THE DISCLOSURE

Exemplary embodiments of the invention are directed to extended power sources for mobile devices and methods for extending the operational duration of mobile devices. More particularly, embodiments of the invention are related to extended batteries that are operational with original equipment batteries that are configured to provide operational and security signals to a mobile device.

### BACKGROUND

Disclosed is a novel battery extension for mobile devices, such as a mobile phone or computing devices. In the past, batteries/power-packs were a relatively large physical component of a mobile device. As mobile devices became smaller, more power efficient, and with the advancement of battery technology, the batteries of the mobile devices were integrated into the bodies of the mobile dc ices In some mobile devices the battery comprises the back cover of the device and in others the battery is inserted into the device.

OEM (original equipment manufacturer) batteries that are originally sold with the mobile devices are specified by the manufacturer to meet certain operational specifications, including operational duration and temperature. Duration of the OEM batteries may be sufficient for some users, but others may need or desire longer performance/operation. In such case, the user has to either carry a spare battery or find opportunities to charge or recharge the battery of the device.

One solution in the prior art is to increase the battery capacity coupled to the mobile device. This was achieved by replacing the original OEM battery with a new battery, different battery, a larger capacity battery, or piggy-backing an extension battery onto the OEM battery (collectively “auxiliary batteries”). The market and the margins for such auxiliary batteries are attractive. To capture the auxiliary battery market, the original equipment manufacturers are incentivised to exclude third parties' auxiliary batteries. In this effort, the original equipment manufacturers developed a proprietary software or hardware lockout, where the mobile device or the OEM battery expects to receive a predetermined signal for full functionality.

### SUMMARY

Exemplary embodiments of the invention are directed to the use of an auxiliary battery with a mobile device that is configured to o era e with an OEM buttery, wherein the mobile device and the OEM battery are configured to operate in the presence of an authentication circuitry or specified authentication signal and/or a set of operational parameters, such as temperature (hereafter collectively referred to as authentication circuitry).

One embodiment discloses an adapter configured on one side to accept the OEM battery and on the other an auxiliary battery. The auxiliary battery and adapter are configured to utilize the space of the mobile device that is reserved for the OEM battery. The contacts of the OEM battery are coupled to the mobile device such that the original pin connections, power flow and authentication signals and circuitry are preserved for the OEM operation with the OEM battery. Additionally, power contacts of the auxiliary battery are coupled to the OEM battery and/or mobile device such that the power capacity to the mobile device is increased. Moreover, to preserve the operational functionality, the contacts of the OEM battery, that channel the authentication signal from authentication circuitry and/or operational parameters between the battery and the mobile device, are isolated/bypassed between the OEM battery and the auxiliary battery. Accordingly, the mobile device does not sense or see the auxiliary battery, yet enjoys the extended power capacity of two or more batteries.

Another embodiment describes a method for extending the power capacity of a mobile device by isolating the contacts of the auxiliary battery from the authentication pins of the OEM battery. This method provides the means for extending the power capacity of the mobile device without interfering with the authentication parameters designed by the original equipment manufacturer.

### BRIEF DESCRIPTION OF THE DRAWINGS

The accompanying drawings found in the attachments are presented to aid in the description of embodiments of the invention and are provided solely for illustration of the embodiments and not limitation thereof.

FIG. 1 shows an illustrative configuration and structure of a prior art, OEM configuration of a battery and mobile device.

FIG. 2 shows an illustrative configuration and structure according to one exemplary embodiment.

FIG. 3 shows a functional configuration according to one exemplary embodiment.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments, Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a,” “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Those of skill in the art will appreciate that information and signals may he represented using any of a variety of different technologies and techniques, including without limitation the traditional analog and digital variations of voltage and current. For example, data, instructions, commands, information, signals, bits, symbols, and chips that may be referenced throughout the above description may be represented by voltages, currents, electromagnetic waves, magnetic fields or particles, optical fields, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

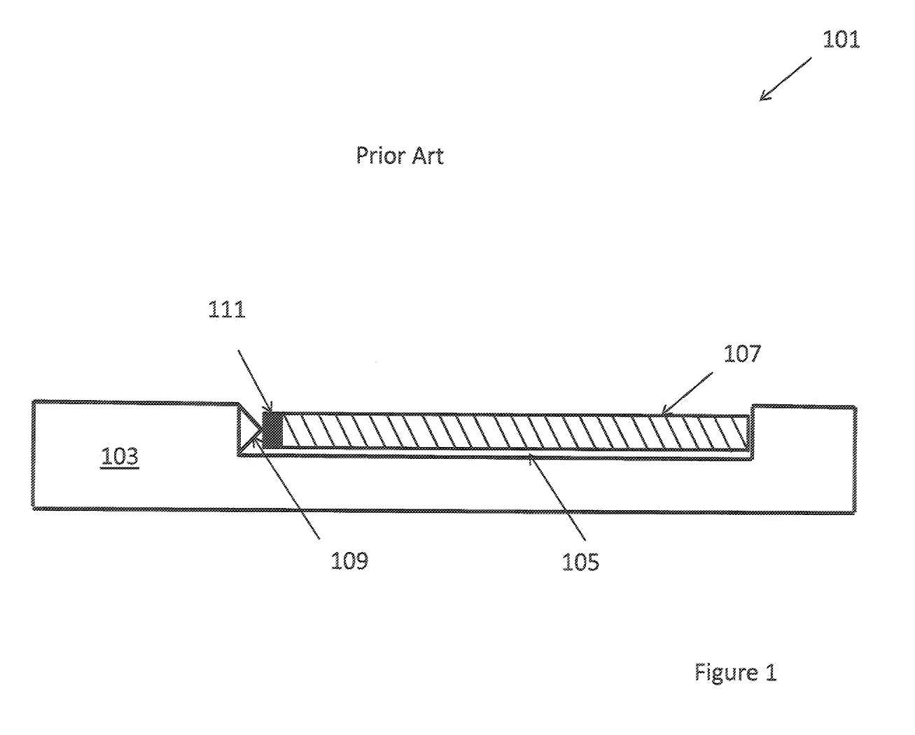

Shown in FIG. 1 is a mobile device 101 having a compartment 105 within a mobile device 103 that is configured to house an OEM battery 107. In an OEM configuration, OEM battery 107 has contacts 111 that are configured to fit and function within or in conjunction with device 103 via matching functional and/or software internconnects represented by a connection 109. Authentication signals, such as security parameters, temperature data, and/or proprietary signals are satisfied for full operation of device 103 and OEM battery 107 when the appropriate connections are made between the device connections 109 and respective battery connections 111. Many batteries incorporate heat sensors 315, such as a thermistor, the value of which is accessible by device 103. Such configuration allows device 103 to authenticate or read the value via corresponding connections 109 and 111 in order disconnect from, to shut off OEM battery 107, or control OEM battery 107 or device 103 in a predetermined way, if OEM battery 107 reaches a threshold temperature that is indicative of malfunction or some other undesirable state. In a similar fashion, device 103 can communicate, validate or authenticate with other functionality or data on board of OEM battery 107. As one example, OEM battery 107 may have a security or authentication IC (integrated circuit) that provides a one time or a continuous signal to the mobile device 103. In the absence of this signal, either during the operation of the device or at initial startup, mobile device 103 may not turn, on, turn off or it may limit or eliminate the functionality available to the user. Although the described authentication and temperature sensing may have useful virtues, its downside is OEM induced incompatibility with third parties' batteries.

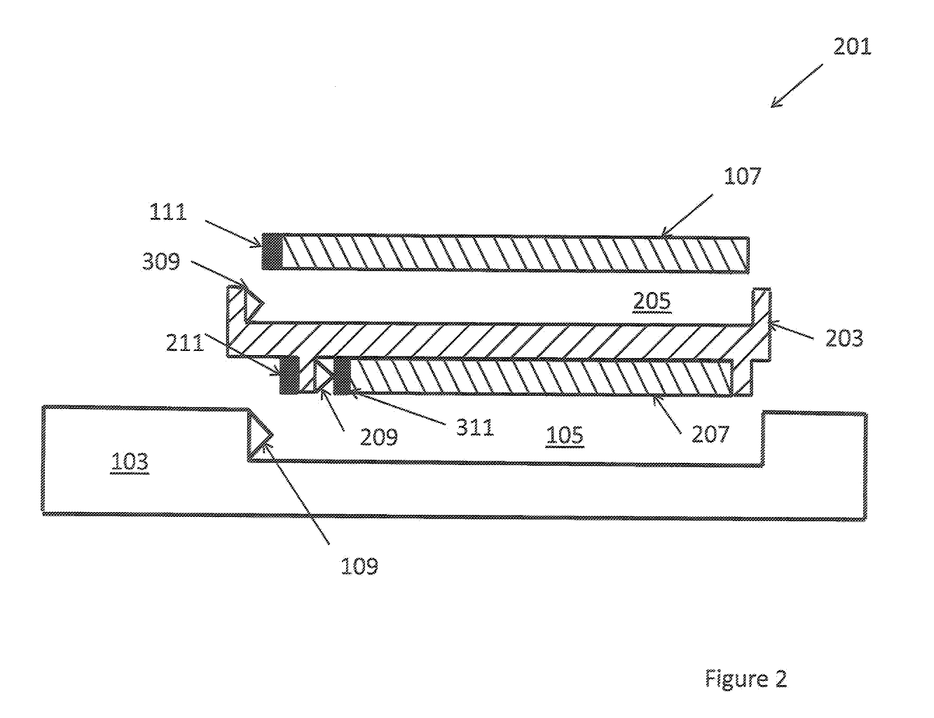

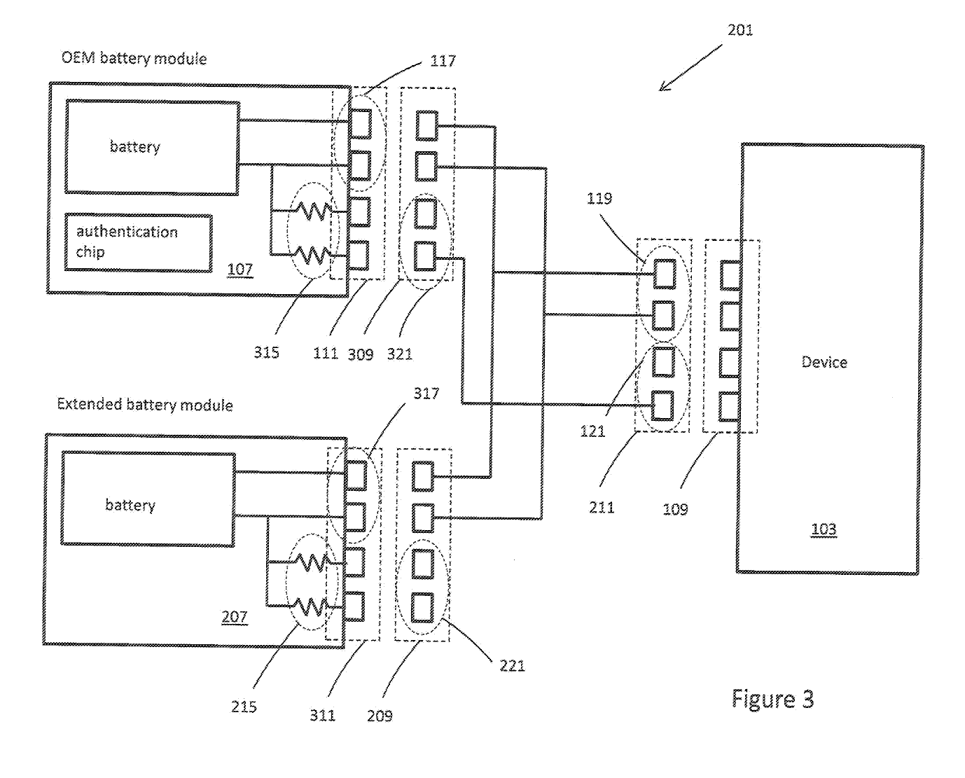

Disclosed in FIGS. 2 and 3 is a system 201, comprising a mobile device 103 having a compartment 105 configured to house OEM battery 107. OEM battery 107 has contacts 111 that are configured to fit and function within or in conjunction with device 103 via matching functional and/or software internconnects represented by connection 109. Security parameters and/or proprietary signals are satisfied for full operation of device 103 and OEM battery 107 when the appropriate connections are made between the device connections 109 and respective battery connections 111. As mentioned above, many OEM batteries incorporate heat sensors 315, such as a thermistor 315, the value of which is accessible by device 103. Such configuration allows device 103 to authenticate or read the value via corresponding connections 121 and 321 in order to shut off OEM battery 107 or control OEM battery 107 or device 103 in a predetermined way if OEM battery 107 reaches a threshold temperature that is indicative of malfunction or some other undesirable state. In a similar fashion, device 103 can communicate, validate or authenticate with other functionality or data on board of OEM battery 107. Accordingly, device 103 will not operate or will not fully operate if it does not sense the expected resistance reading that is built into OEM battery 107 or an authentication code sent between the OEM battery 107 and device 103. This is the case because an additional battery that is added in parallel to the OEM battery 107 through all of its contacts, affects the resistance, capacitance and inductive values of the overall circuit or the authentication signal. Similarly, in-gross parallel connection or substitution of the OEM battery with a third party battery would likely fail or falter the expected authentication circuit or signal.

The embodiment shown in FIG. 2 extends the power capacity of OEM battery 107 by employing an adapter 203 that is configured to fit into the battery compartment 105 and/or in place of OEM battery 107 on the first of its two sides. In embodiments where the OEM battery 107 is externally mounted to the device 103, adapter 203 represents a device that is configured to take the position of the OEM battery 107. In one embodiment adapter 203 is configured with contacts 309 that couple to OEM battery 107. Such contacts are physically and functionally configured to be compatible with and physically accept the OEM battery 107 in a compartment 205. In an exemplery embodiment, adapter 203 is configured to accept an auxiliary battery 207 on the second side of compartment 205, although one of ordinary skill in the art will appreciate that the physical location of the OEM battery 107 and auxiliary battery 207 are not significant.

Further, contacts 309 are selectively coupled to second contacts 209, which are shown FIG. 2 on the second side of adapter 203. As further illustrated in FIG. 3, selected power contacts 309 and 209 arc arranged in an electrically parallel configuration so that the DC or power pins 117 of the OEM battery 107 and the selected power pins 317 of the auxiliary battery 207 are electrically coupled in a parallel fashion through the corresponding connectors 209, 309 and 211 to provide power to device 103. However, the non-power pins 221 and 321 are specifically isolated between the two batteries 107 and 207 to preserve the authenticity signals and sensor data between device 103 and OEM battery 107 in the presence of auxiliary battery 207 and its authentication circuitry 215.

As is shown in further detail in FIG. 3, accordingly, when selected power contacts 317 of auxiliary battery 207 are connected to contacts 209, power contacts 117 and 317 of of the two batteries 107 and 207 are in parallel connection and provide power to the device 103 via contacts 119 of contacts 211. However, the authentication signals between the device 103 and OEM battery 107 are limited to device 103 and OEM battery 107 through contacts 321 of contacts 309 connected to contacts 111 and therein authentication circuitry 315 feeding authentication signals and to the exclusion of circuitry 215 of the auxiliary battery 207. Thus, authentication signal(s) and or authentication circuitry 315 is isolated from authentication circuitry 215 of the auxiliary battery 207 and from contacts 121 of contacts 211 which are coupled to contacts 109 of device 103. The configuration described herein allows the use auxiliary battery 207 by coupling the power connections of the auxiliary battery 207 in parallel with the power connections of OEM battery 107 and providing the power of both of the batteries to device 103. Moreover, the authentication circuitry 315 and authentication signal(s) of OEM battery 107 continues to be accessible and is in connection with device 103 and at the same time is not affected by the absence or presence of authentication signals 215 from auxiliary battery 207, due to the isolation of the corresponding pins/connections from the auxiliary battery to the OEM battery 107 and/or device 103.

In another exemlery embodiment a method for providing extended power comprises providing auxiliary battery 207 and connecting auxiliary battery 207 through its selected power contacts 317 to contacts 209, thus connecting power contacts 117 and 317 of of the two batteries 107 and 207 are in parallel connection and providing power to the device 103 via contacts 119 of contacts 211. In this method, the authentication signals and circuitry 315 between the device 103 and OEM battery 107 are limited to device 103 and OEM battery 107 through contacts 321 of contacts 309 connected to contacts 111 and therein contacts 315 feeding authentication signals. Thus, authentication signal(s) flowing through contacts 315 are isolated from authentication circuitry 215 and contacts 221 connected of battery 207 and from contacts 121 of contacts 211 which are coupled to contacts 109 of device 103. The configuration described herein allows the use auxiliary battery 207 by coupling the power connections of the auxiliary battery 207 in parallel with the power connections of OEM battery 107 and providing the power of both of the batteries to device 103. Therefore, by isolating the corresponding pins/connections from the auxiliary battery 207 to the OEM battery 107 and/or device 103, the authentication circuitry and signal(s) 315 of OEM battery 107 continue to be accessible and is in connection with device 103; and at the same time they are isolated or immuned from the absence or presence of authentication signals 215 from auxiliary battery 207.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not he performed in any particular order. Furthermore, although elements of the invention may be described or claimed in the singular, the plural is contemplated unless limitation to the singular is explicitly stated.

I claim:

1. An adapter configured to couple an auxiliary battery for use with a portable device, the adapter comprising:
a compartment to house the auxiliary battery;
a second set of contacts configured to selectively connect power contacts of the auxiliary battery to a third set of contacts and configured to isolate non-power contacts of the auxiliary battery from the portable device and from an OEM battery;
a fourth set of contacts configured to connect to the OEM battery further comprising power contacts and at least one contact for coupling of at least one authentication circuit with the portable device, wherein the third set of contacts is configured to connect with a first set of contacts of the portable device and the fourth set of contacts configured to connect with the OEM battery;
wherein the OEM battery further comprises the authentication circuit configured to authenticate the OEM battery with the portable device.

2. The adapter of claim 1 further comprising a cover configured to cover at least one of the OEM battery and the adapter.

3. The adapter of claim 1, wherein the authentication circuit is set to a predetermined resistance value that is acceptable to the portable device.

4. The adapter of claim 1, wherein the authentication circuit is at least one resistor of a predetermined resistance value that is acceptable to the portable device.

5. The adapter of claim 1, wherein the authentication circuit generates a signal corresponding to temperature of at least one of the OEM battery or the auxiliary battery that is acceptable to the portable device.

6. The adapter of claim 1, wherein the authentication circuit is a thermistor generating a signal corresponding to temperature of at least one of the OEM battery or the auxiliary battery that is acceptable to the portable device.

7. The adapter of claim 1, wherein the authentication circuit is set to a digital co e that is acceptable to the portable device.

8. The adapter of claim 1, wherein the authentication circuit is a memory register hosting a digital code that is acceptable to the portable device.

9. A method for coupling an auxiliary battery to a portable device employing an OEM battery coupled to authentication circuitry, the method comprising:
coupling power contacts of an auxiliary battery to the portable device in parallel with power contacts of the OEM battery;
and isolating non-power contacts of the auxiliary battery from at least one of non-power contacts of the OEM battery or non-power contacts of the portable device.

10. The method of claim 9, wherein the authentication circuit is set to a predetermined resistance value that is acceptable to the portable device.

11. The method of claim 9, wherein the authentication circuit generates a signal corresponding to temperature of at least one of the OEM battery or the auxiliary battery that is acceptable to the portable device.

12. The method of claim 9, wherein the authentication circuit is set to a digital code that is acceptable to the portable device.

13. An adapter configured to couple an auxiliary battery for use with a portable device, the adapter comprising:
a compartment means for housing the auxiliary battery;
a second set of contact means for selectively connecting power contacts of the auxiliary battery to a third set of contact means and for isolating non-power contacts of the auxiliary battery from the portable device and from an OEM battery;
a fourth set of contact means for connecting to the OEM battery further comprising, power contacts and at least one contact means for coupling of at least one authentication means for authenticating the OEM battery with the device, with the portable device, wherein the third set of contact meanss is configured to connect with a first set of contact means of the portable device and the fourth set of contact means for connecting with the OEM battery; and
wherein the OEM battery further comprises the authetication circuit configured to authenticate the OEM battery with the portable device.

14. The adapter of claim 13 further comprising a cover means for covering at least one of the OEM battery and the adapter.

15. The adapter of claim 13, wherein the authentication circuit means is set to a predetermined resistance value that is acceptable to the portable device.

16. The adapter of claim 13, wherein the authentication circuit means is at least one resistor of a predetermined resistance value that is acceptable to the portable device.

17. The adapter of claim 13, wherein the authentication circuit means generates a signal corresponding to temperature of at least one of the OEM battery or the auxiliary battery that is acceptable to the portable device.

18. The adapter of claim 13, wherein the authentication circuit means is a thermistor means for generating a signal corresponding to temperature of at least one of the OEM battery or the auxiliary battery that is acceptable to the portable device.

19. The adapter of claim 13, wherein the authentication circuit means is set to a digital code that is acceptable to the portable device.

20. The adapter of claim 13, wherein the authentication circuit means is a memory register means for hosting a digital code that is acceptable to the portable device.
